(19) United States
(12) Patent Application Publication
(10) Pub. No.: US 2013/0127637 A1
(43) Pub. Date: May 23, 2013

(54) METHOD AND SYSTEM FOR COMPRESSING BITPLANES BASED ON BIT POSITION

(71) Applicants: Gadiel Seroussi, Cupertino, CA (US); Marcelo Weinberger, San Jose, CA (US); Raul Heman Etkin, Oakland, CA (US); Erik Ordentlich, San Jose, CA (US)

(72) Inventors: Gadiel Seroussi, Cupertino, CA (US); Marcelo Weinberger, San Jose, CA (US); Raul Heman Etkin, Oakland, CA (US); Erik Ordentlich, San Jose, CA (US)

(21) Appl. No.: 13/812,037

(22) PCT Filed: Jul. 26, 2010
(86) PCT No.: PCT/US10/43275

§ 371 Date: Jan. 24, 2013

(51) Int. Cl. H04W 52/02

(52) U.S. Cl. CPC H04W 52/0209
USPC 340/870.39

(57) ABSTRACT

A technology is provided for compressing digital discrete node data to reduce overall power consumption. Node data can be represented by a plurality of data units with a specified data width and can also be viewed as a plurality of bit planes corresponding to data at each bit position for the data units. A threshold bit position value may be selected for data units using an achievable compressibility estimate relative to an estimated energy consumption. The threshold bit position value can represent a boundary where an estimated energy consumption for compressing and transmitting a bit plane is less than an estimated energy consumption for transmitting the bit plane uncompressed. A bit plane is selected in the plurality of bit planes with a bit position value greater than the threshold bit position value. The bit plane is compressed using a compressor in the networked node.

### BACKGROUND

Sensor networks can gather information from many remote sensor nodes into collectors and process the data based on the information received at the collectors or transmit the collected data to a central processor. The remote sensor node can include a transducer that converts energy or an input monitored by the sensor to an electrical or digital signal. Remote sensors nodes may be some distance away from the collectors and use an independent power source, like batteries, capacitors, or solar cells, because of a lack of availability of commercial grid electricity.

Due to the distance of remote sensor nodes from the collector, the remote sensor nodes may transmit a signal with data to the collector via a wireless communication device. The power used to transmit the data can discharge the power from the independent power source and can reduce the limited power available from the independent power source for the remote sensor node or shorten the time the remote sensor node can use the independent power source. Reducing the power consumption of the remote sensor node can extend the life of the independent power source, enhance the reliability of the network, and extend the time data can be collected by the remote sensor nodes.

### BRIEF DESCRIPTION OF THE DRAWINGS

FIG. 1 is an illustration of a system with network nodes and a network collector in accordance with an embodiment;

FIG. 2A is an illustration of node data represented by a plurality of data units with a specified data width in accordance with an embodiment;

FIG. 2B is an illustration of node data represented by a plurality of bit planes corresponding to data at each bit position for the data units in accordance with an embodiment;

FIG. 3A is an illustration of bit plane compression in accordance with an embodiment;

FIG. 3B is an illustration of a data unit with a threshold bit position, a most significant bit (MSB), and a least significant bit (LSB) in accordance with an embodiment;

FIG. 4A is an illustration of uncompressed node data in accordance with an embodiment;

FIG. 4B is an illustration of node data with compressed bit planes with bit position values greater than the threshold bit position value and uncompressed bit planes with bit position values less than or equal to the threshold bit position value in accordance with an embodiment;

FIG. 5 is an illustration of a remote sensor network node in accordance with an embodiment;

FIG. 6 is a flowchart illustrating a method for compressing digital discrete node data based on a bit position to reduce overall power consumption of a networked node in accordance with an embodiment; and

FIG. 7 is a flowchart illustrating a method for compressing digital discrete node data based on a bit position to reduce overall power consumption of a networked node in accordance with an embodiment.

### DETAILED DESCRIPTION

Alterations and further modifications of the features illustrated herein, and additional applications of the principles of the technology as illustrated herein, which would occur to one skilled in the relevant art and having possession of this disclosure, are to be considered within the scope of the technology. The same reference numerals in different drawings represent the same element.

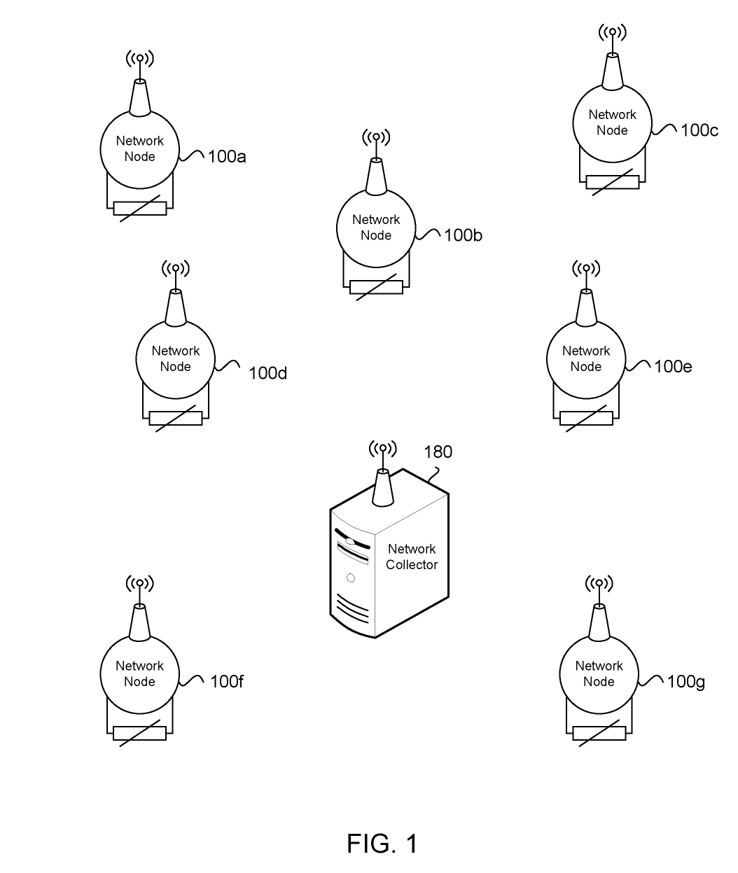

As illustrated in FIG. 1, a network may include a network node 100a that may communicate with another network node 100c via transmitters and receivers or the network node may communicate with a network collector 180. The network node may communicate with other network nodes or the network collector via wireless, optical, fiber optic, wired, infra-red, or similar types of communication channels. The network node may be a sensor node or a remote sensor network node. The network may be a sensor network. The network node may be used for gathering data, like pressure, acceleration, and temperature, and may be positioned at specified locations some distance from the network collector. The network node may be a low power consumption device or a battery powered device.

The network collector 180 may collect the data from network nodes, and the network collector may combine and process the data into a database of information. The network collector may include a processor, storage device, a transmitter and/or receiver, and a power source. The collector may process large volumes of information and may not have the same power consumption constraints as the network nodes. The power source for the collector may include commercially produced alternating current (AC) grid electricity.

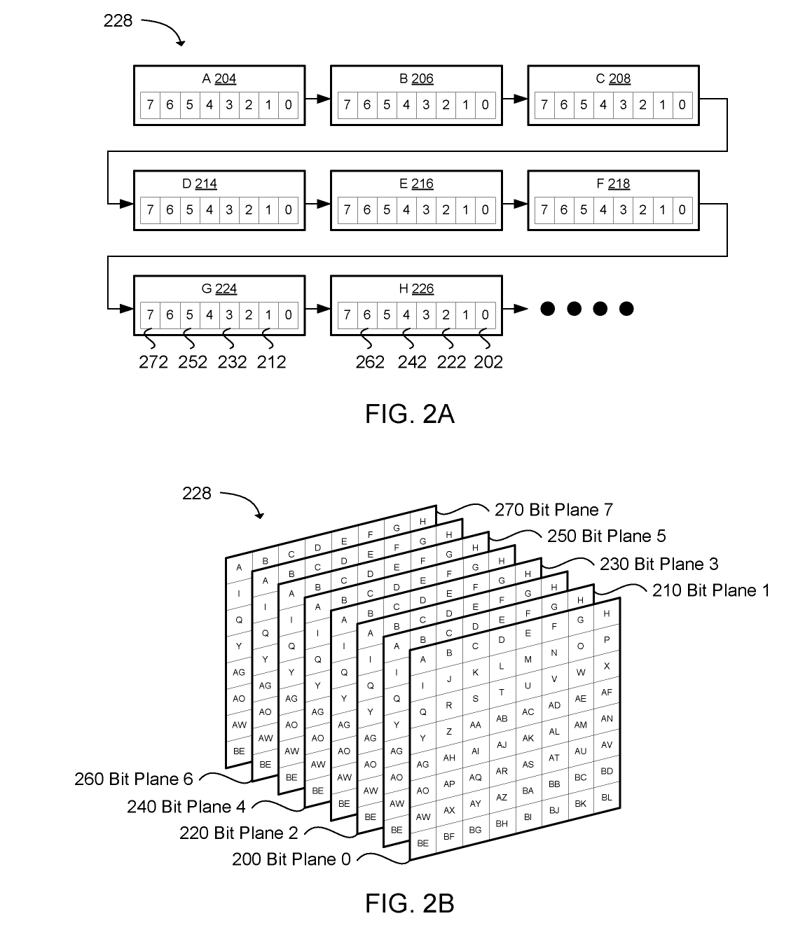

As illustrated in FIG. 2A, node data 228 may be represented by a plurality of data units with a specified data width. For example, the data width may be 2-bits, 3-bits, 4-bits, 8-bits, 12-bits, 16-bits, 4 bytes wide, or any data width with a plurality of data units (as in FIG. 2A). In some configurations, the data will be signed and a sign bit can be used in the data width. The data units of the node data may be sent sequentially from one element to another element of the node using a data bus (e.g., sent from the sensor to the processor). For example, the first data unit A 204 may be followed by data units B 206, C 208, D 214, E 216, F 218, G 224, H 226, and other data units. The data unit may have a most significant bit (MSB) 272 and a least significant bit (LSB) 202 with bits 262, 252, 242, 232, 222, 212 in order from the MSB to the LSB. In one example, the data units may also correspond to a sequence of data measurements over time, where each data unit represents a single measurement.

As illustrated in FIG. 2B, the node data may be viewed as a plurality of bit planes where each bit plane corresponds to data at each bit position for the data units. A bit plane can refer to the location of the data in memory. For example, the eight (8) bits of data unit A 204 (FIG. 2A) can be located at the same point on each of the eight (8) respective bit planes 200, 210, 220, 230, 240, 250, 260, 270. A 0-bit bit plane 200 may include the zero-position bits 202 of the data units and likewise for the other bit planes and bits of the data unit. Each bit in a data unit or bit plane in node data may represent a different level or resolution of the node data. Each bit plane may have a similar resolution.

Due to the limited power that may be available to a node, reducing the power consumption of the electronic components and elements of the network node may extend the functional life or functionality of the node. The node may have an energy budget including the energy available and the energy spent or consumed.

The network nodes may have limited computing capabilities and power consumption availability, but may handle a large amount of data. A method for compressing digital discrete node data based on a bit position to reduce overall power consumption of a networked node may provide a “knob” that controls how much of the data the compressor may compress with the node's limited resources, where the most compressible part is given preference. A threshold bit position value may be used to optimize the applicability of statistical assumptions for the node data or a signal. The method may prevent an attempt to compress noise and very noisy data by including a “noise” parameter in an achievable compressibility estimate. The threshold bit position value may also be used to determine which bits may be compressed and which bits may be stored or sent uncompressed so that the power savings achieved by compression outweighs the power consumption caused by the associated computations, and the total power consumption is within budget. Furthermore, in applications that allow some degree of data loss, it may be possible to discard some of the “noisy” bits. In these cases, some of the bits are sent compressed, others are sent uncompressed, while the remaining bits are discarded.

For example, in seismic sampling, a first bit plane or a most significant bit (MSB) bit plane may give the roughest approximation of values of a data signal, and the lower the significance of the bit order of the bit plane, the lower the significance of the bit plane's contribution to the data. Thus, each additional bit plane may give a better approximation of the signal. The bits belonging to a first bit plane and a designated number of lower bit order bit planes for a sample may be referred to as a truncated sample.

A bit plane further away from the MSB bit plane may have more variation, including changes in binary values, between a reference sample and adjacent or neighboring samples, and may not have characteristics that can be compressed or may not provide a power saving benefit from compression (e.g., where compression and transmission of the compressed bit plane uses less power than transmission of the bit plane uncompressed). Bit planes further away from the MSB bit plane may be susceptible to noise, affected by noise, or include noise due to the capturing mechanism of a sensor input. Noise may be an unwanted perturbation to a wanted signal. Bit planes corrupted by noise may be less compressible than an uncorrupted bit plane.

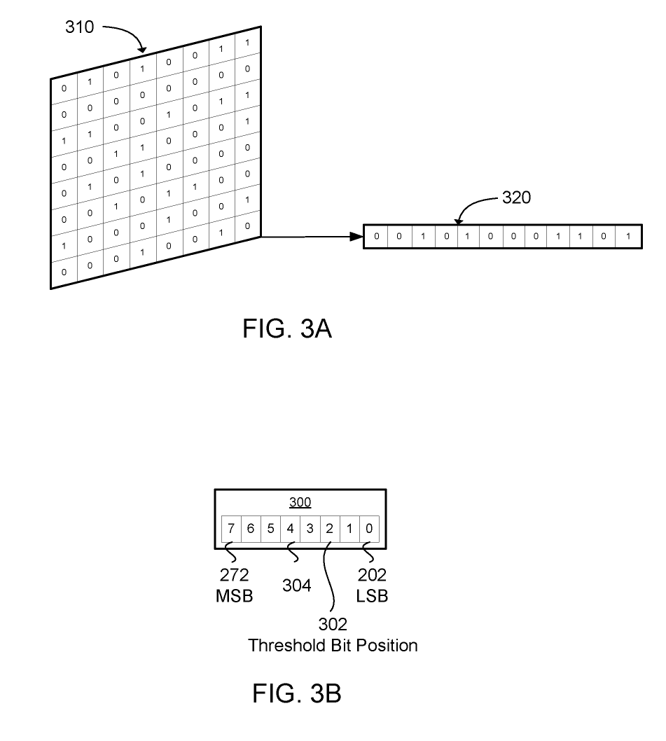

As illustrated in FIG. 3A, a bit plane 310 may be compressed into a compressed bit stream 320. Bit planes with a higher compression ratio may benefit from transmitting the bit plane compressed while bit planes with a lower compression ratio may benefit from transmitting the bit plane uncompressed. While the uncompressed bit planes have been displayed using an intuitive 2D (two-dimensional) interpretation, the bit planes can also be thought of without necessarily a 2D interpretation (e.g. can be thought of using a 1D interpretation.)

The MSB bit plane, LSB bit plane, or any bit plane of the node data may achieve a greater compressibility than another bit plane of the node data. For example, the MSB bit plane may be more compressible than the LSB bit plane with the bit planes in between having data compressibility that moves from greater compressibility to less compressibility from the MSB bit plane to the LSB bit plane. In another embodiment, the LSB bit plane may be more compressible than the MSB bit plane with the compressibility ranging from high compressibility of the LSB bit plane to the lower compressibility of the MSB bit plane. For purposes of clarity and illustration herein, the MSB bit plane represents the highest compressibility of the node data bit planes, and the LSB bit plane represents the lowest compressibility of the node data bit planes, with a bit plane closer in bit value to the MSB having a higher compressibility than a bit plane further away in bit value to the MSB. For example, the 4th bit plane representing the 4-bits 304 in the data unit 300 (FIG. 3B) may be more compressible than the 3rd bit plane representing the 3-bit, because the 4-bit may be closer in position to the 7-bit or MSB 272 than the 3-bit in the data unit.

In cases where the compressibility of the different bit planes does not increase from the LSB to the MSB bit planes, a permutation function may be applied to the bit plane labels so that after the appropriate permutation is applied, the resulting bit plane ordering satisfies the condition that the compressibility increases from the (permuted) LSB to the (permuted) MSB bit planes. Alternatively, instead of using a threshold to determine which bit planes to compress and which bit planes to leave uncompressed, a more general binary function may be applied to each bit plane to determine whether it should be compressed or not. For the specific case of the threshold, the binary function is f(BP)=1(BP>TH) where BP is the bit plane number, TH is the threshold, 1(.) is the indicator function, and f(BP)=1 whenever the bit plane is to be compressed.

As illustrated in FIG. 3B, a threshold bit position value 302 for a data unit 300 may be selected using a compressibility estimate relative to an estimated power consumption of the compression of a bit plane and the estimated power consumption to transmit the bit plane. The compressibility estimate may be a compression ratio. The compressibility estimate may estimate the data compression based on each bit plane's position value for a type of node data. The type of node data may be acceleration data, seismic data, strain data, pathogen data, graphic data, digital photo data, or other type of node data generated by a sensor. For example, the MSB bit plane compression ratio estimate for seismic samples may be 30 to 1 while the LSB bit plane compression ratio estimate for seismic samples may be 1.5 to 1. The compressibility estimate may be determined by each bit position and each type of data based on historical data. The compressibility estimate may use a statistical model or stochastic model for each of the bit planes. For example, statistics may be computed for a subset of the bit planes to determine if the values comprised of corresponding bits from the subset of bit planes can be well modeled by a function of previously processed values plus a random variable distributed according to a two-sided geometric distribution (TSGD), which can be an indicator of a high data compression ratio for the bit planes. The compressibility estimate may be stored in data storage in the node. The compressibility estimate may be stored as a table or parameters. A compression algorithm may be tailored to the type of data, the bit position of the data unit, and/or the bit plane.

The estimated energy consumption for processing a bit plane may include the energy used to obtain or generate the bit plane, compress the bit plane, transmit the bit plane, or store the bit plane for each type of node data. The estimated energy for compressing a bit plane may be the estimate of the energy consumption of the compression process used to compress the bit plane for a type of node data. The estimated energy for compressing a bit plane may use historical measurements of compressing a bit plane. The energy consumption estimate for a bit plane may be stored by data storage module in the node. The estimated energy consumption may be represented by an energy measurement. The estimated energy consumption may be an energy estimate for the entire bit plane or average per bit cost (multiplied by the total number of bits in the bit plane). Although compression refers to the entire bit plane, the energy cost assignment may be referred to as a per bit energy cost for simplicity of illustration. Using a first example bit plane with a compressibility ratio of 10 to 1, the estimated energy to transmit an average bit in the uncompressed first example bit plane may be 10 microJoules. The estimated energy to compress a bit plane represented by an average bit cost (the energy cost of compressing the bit plane divided by the total number of uncompressed bits in the bit plane) may be 4 microJoules and the estimated energy to transmit a compressed bit plane in a compressed first example bit plane, represented by an average bit cost (the energy cost of transmitting the compressed bits divided by the total number of uncompressed bits in the bit plane), may be 1 microJoule (1/10th the number of bits transmitted×10 microJoules per bit transmitted) for a total of 5 microJoules. The average bit cost for compressing and transmitting the first example bit plane (5 μJ per uncompressed bit) may use less energy or consume less energy at the node than transmitting the first example bit plane uncompressed (10 μJ per uncompressed bit).

Using a compression ratio of a second example bit plane of 1.25 to 1 may show no energy savings in compressing the second example bit plane. The estimated energy to transmit an average bit in the uncompressed second example bit plane may be 10 microJoules, similar to the estimated energy to transmit an average bit in the uncompressed first bit plane. The estimated energy to compress a bit plane represented by an average bit cost (the energy cost of compressing the bit plane divided by the total number of uncompressed bits in the bit plane) may be 4 microJoules and the estimated energy to transmit a compressed bit plane in a compressed second example bit plane, represented by an average bit cost, may be 8 microJoules (1/1.25th the number of bits transmitted×10 microJoules per bit transmitted) for a total of 12 microJoules. Compressing and transmitting the second example bit plane (12 μJ per bit) may use more energy or consume more energy at the node than transmitting the second example bit plane uncompressed (10 μJ per bit). So transmitting the second example bit plane uncompressed may be preferred over compressing and then transmitting the bit plane. The transmission power may vary over time depending on channel conditions and other transmission conditions, so the threshold may vary dynamically over time in response to the varying transmission power needed.

Referring again to FIG. 3B, the threshold bit position value 302 may represent a bit position in a data unit 300. For example, the threshold bit position may be the second-bit 302. The threshold bit position value may be a boundary where an estimated energy consumption for compressing and transmitting a bit plane is less than an estimated energy consumption for transmitting the bit plane uncompressed for a bit position value greater than the threshold. For example, one bit plane may be greater than the threshold bit position value, while another bit plane may be less than or equal to the threshold bit position value.

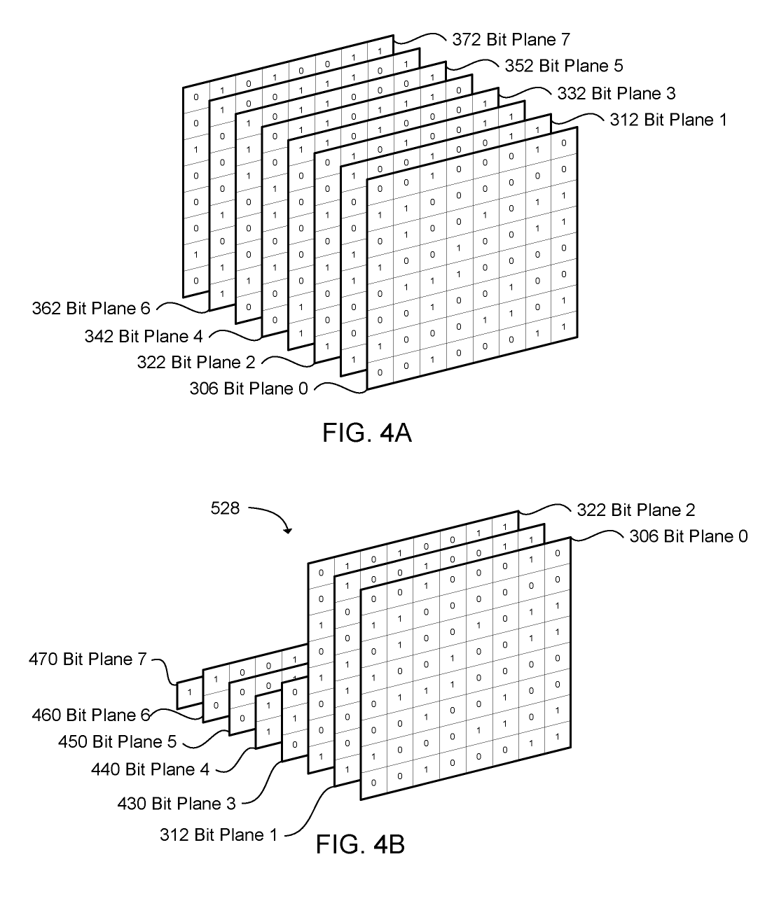

A bit plane for compression may be selected with a bit position value greater than the threshold bit position value. For example, the threshold bit position value may be the second-bit 302 (FIG. 3A). As illustrated in FIG. 4A, a bit plane may be bit plane 3 332, bit plane 4 342, bit plane 5 352, bit plane 6 362, or bit plane 7 372 and may represent bit values of the third-bit 232, fourth-bit 242, fifth-bit 252, sixth-bit 262, or seventh-bit 272 in the data unit, respectively (FIG. 2A). The bit plane (bit plane 3 332, bit plane 4 342, bit plane 5 352, bit plane 6 362, or bit plane 7 372 ) of FIG. 4A, may be compressed by a compressor generating compressed bit planes 3-7 430-470, as illustrated in FIG. 4B. The bit planes (bit plane 0 306, bit plane 1 312, or bit plane 2 322) less than or equal to the threshold bit position value may remain uncompressed.

In a further example, the node data may be a data sequence or bit stream that can be generated, sampled, or collected sequentially (e.g. sampled data including a sequence of 8-bit data values). In estimating the compressibility based on a statistical model of the data, as well as in compressing the bit-planes of the sampled data corresponding to bit-positions that are designated for compression (e.g., those bit positions greater than a threshold bit position), the network node may compute a prediction for a truncated data value or sample corresponding to the bits to be compressed, wherein the prediction is determined from previously processed data values.

The prediction of a truncated data sample may then be subtracted from the truncated data sample to generate a corresponding prediction error. The sequence of corresponding prediction errors for several choices of the bit-position threshold may be used to compute a threshold bit position value or boundary for determining which bits to compress and which to store or send uncompressed. The network node may compress or encode the data sequence after each sample or collection of the node data or after a predetermined number of samples. The bits in the prediction error value for each truncated sample may be encoded as the samples of the data sequence are generated or received.

For bit planes that are rough approximations, the probability that adjacent truncated samples to a reference truncated sample will have a similar value will be high. When the probability that an adjacent truncated sample will have a similar value may be high, the prediction error may be low. Adjacent truncated samples sharing similar values may have characteristics that allow for data compression. Many measurements generated by sensors from natural signals and events can exhibit characteristics that allow for data compression of a subset of the bit planes.

In another embodiment, prediction errors are computed based on non-truncated data samples, and the bit-planes of the prediction error values are selectively compressed and uncompressed (e.g. depending on their position relative to a bit-position threshold).

For example, sampled data may be illustrated as a sequence of ten 8-bit data values Sequence 1.

x8[1 . . . 10]=79, 159, 88, 103, 88, 124, 15, 4, 7, 1 [Sequence 1]

The 8-bit data values of Sequence 1 may be truncated to 7 bits Sequence 2, 6 bits Sequence 3, and 5 bits Sequence 4, respectively. Truncation may eliminate least significant bits.

x7[1 . . . 10]=39, 79, 44, 51, 44, 62, 7, 2, 3, 0 [Sequence 2]

x6[1 . . . 10]=19, 39, 22, 25, 22, 31, 3, 1, 1, 0 [Sequence 3]

x5[1 . . . 10]=9, 19, 11, 12, 11, 15, 1, 0, 0, 0 [Sequence 4]

Each of the ten samples in Sequences 1-4 can be predicted with the sample that precedes the sample being predicted. Assume for illustration that the first value is preceded by a zero and truncation of the sequence precedes prediction of the sequence. The sequence of prediction errors Error Sequences 1-4 corresponding to respective Sequences 1-4 may be calculated. The error e[n] may be represented by ei[n]=xi[n]−xi[n−1].

e8[1 . . . 10]=79, 80, −71, 15, −15, 36, −109, −11, 3, −6 [Error Sequence 1]

e7[1 . . . 10]=39, 40, −35, 7, −7, 18, −55, −5, 1, −3 [Error Sequence 2]

e6[1 . . . 10]=19, 20, −17, 3, −3, 9, −28, −2, 0, −1 [Error Sequence 3]

e5[1 . . . 10]=9, 10, −8, 1, −1, 4, −14, −1, 0, 0 [Error Sequence 4]

For each sequence of prediction errors Error Sequences 1-4, the average of absolute values and the average of the squares of the elements of the sequence may be computed. Assuming the prediction errors for the i-bit quantities are samples of some random variable then the computed quantities may be estimates a′ and v′, respectively, of a=E[|Rᵢ|] and v=E[Rᵢ^{2 ], where E[ ] denotes expectation. Furthermore, if R}ᵢ is distributed according to a zero-centered two-sided geometric distribution (TSGD), i.e. P(Rᵢ=r)=C·t^{|r|} for some parameter t, 0<t<1, appropriate constant C, and all integers r, then v may be represented by v=V(a)=a²+a·sqrt(a²+1). Table 1 may summarize the empirical estimates a′ and v′ computed from the sample Sequence 1 and the truncated samples Sequences 2-4, the alternative estimate v″=V(a′) of v, and the relative difference between v″ and v′ or the v error. In a typical sample from a TSGD, the percentage difference in the v″ and v′ may be small.

TABLE 1

| bits | a′ | v′ | v″ | v error |
|---|---|---|---|---|
| 8 | 42.5 | 3147.50 | 3613.0 | 12.88% |
| 7 | 21.0 | 782.80 | 882.5 | 11.30% |
| 6 | 10.2 | 193.80 | 208.6 | 7.09% |
| 5 | 4.8 | 46.00 | 46.6 | 1.23% |

The relative difference between v″ and v′ can drop significantly by truncating the Sequence data to 5 bits. Setting a decision threshold or v error value at 5%, the prediction errors corresponding to the sequence of data samples Sequence 4 truncated to 5 bits may have a distribution modeled by a TSGD.

A compressor may encode the 5-bit prediction error sequence (Error Sequence 4) with an appropriate Golomb code and a transmitter may transmit the encoded 5-bit prediction errors. The Golomb code parameters may be collected from statistics according to formulas known in the art. In this illustration, the remaining 3-bits of each data value (those eliminated by the truncation to 5-bits) may be transmitted or stored uncompressed.

The compression of selected bit planes may use a compression method based on Golomb coding, arithmetic coding, and/or run-length coding, using techniques known in the art of data compression. These coding techniques may generally be applied on prediction errors or transformed data (a prediction error can be seen as a special case of transformed data), as illustrated previously.

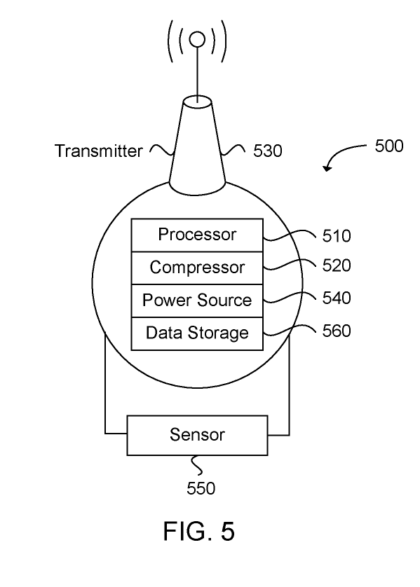

An example of a network node configuration will now be described, as illustrated in FIG. 5. The network node (or node) 500 may include a sensor 550, a transmitter 530, a compressor 520, a processor 510, data storage module 560, and a power source 540. The sensor 550 may convert a measurable input into an electrical signal or digital data. The network node may obtain node data organized by data units and select a threshold value for the data unit. The network node may compress the most significant bits or most significant bit planes greater than the threshold value and transmit the compressed most significant bits or compressed most significant bit planes greater than the threshold value. Then, the network node may transmit uncompressed least significant bits or uncompressed least significant bit planes less than the threshold value.

The sensor 550 may be a transducer that can transform one type of energy or measureable input into digital data or node data. The transducer can make a conversion from electrical, mechanical, electromagnetic, photonic, photovoltaic, acoustic, or any other form of energy that can be converted into an electrical signal or digital data. For example, the transducers may convert energy associated with movement, light, temperature (heat), pH, humidity, sound, pressure, or airflow into an electrical signal or digital data. The measurable input of the transducer may include an input by a living object (including plant or animal) or human operator. The node may include an analog-to-digital converter (ADC) to convert an analog electrical sensor output signal into discrete digital node data.

The transmitter 530 may use any electronic or optical device for wireless communication. The transmitter may transmit via wires or optical cables. The transmitter may be configured to use low power components or consume low amounts of power.

The compressor 520 may include a compression module or lossless data compression process for compressing node data or a portion of node data so the original data may be reconstructed or restored by a decompressor using a decompression process for decompressing node data. The network collector may have a decompressor that can reconstruct the original node data from compressed node data without any loss in data accuracy from the compression process. The compressor may encode or compress the node data. The compressor may include an encoder or an encoding processor. The compressor may encode the node data using a Golomb code. The compressor may be a lossless compressor based on low complexity estimation and coding procedures. The compressor of the node may alternatively be a statistics-based compressor or a statistical compressor, such as an arithmetic coder, that can be implemented per individual bit plane in a bit plane by bit plane sequence. The compressor may also be a low complexity compressor for sensed data with controllable compression power, in which case the achievable compression ratio and corresponding power consumption can be selected to minimize the overall power consumption. The compressor may be a low complexity lossless data compressor embedded with the sensor 550.

The compressor 520 may include a lossy data compression module for compressing node data or a portion of node data so that an approximation to the original data may be obtained by a suitable decompressor. The reconstructed data may exhibit some distortion with respect to the original data, and as a result, there may be some degree of data loss. Lossy compression may result in overall power savings as compared to lossless data compression due to better data compression ratios and lower compression and transmission power consumption. An example lossy data compression method may include discarding (i.e. not transmitting) some of the noisiest bit planes.

The processor 510 may segment the node data, organize the node data into bit planes, or assign a threshold bit position value used to establish a boundary between compressed bit planes and uncompressed bit planes. The processor may include the compressor or compression function of the compressor.

The data storage module 560 may be used to store compressed or uncompressed node data or original digital data from the sensor. The data storage may be a memory device. The data storage may be a RAM, EPROM, flash drive, optical drive, magnetic hard drive, or other medium for storing electronic data.

The power source 540 may be a self-contained power source, like an electrochemical device (e.g., a battery), or an electric device (e.g., capacitor, super-capacitor, or ultra-capacitor, inductor, solar cell, or similar electrical device that can store energy). The self-contained power source may generate electrical power independently of commercial AC grid power using renewable energy sources including but not limited to devices using wind power, thermal power, solar power, solar thermal energy, or biofuel. The self-contained power source may have limited energy or power available before being recharged, renewed, or replaced.

The electronic components of the node 500 may consume power from the power source 540 through the use of the processor 510, the compressor 520, the transmitter 530, the sensor 550, or data storage module 560.

In another embodiment, a system for compressing digital discrete node data based on a threshold bit position may include a network node 500 with a processor 510, a compressor 520, a transmitter 530, a power source 540, a sensor 550, or a storage device 560. The processor may select the threshold bit position value. The compressor may compress a bit plane. The transmitter may transmit uncompressed and compressed bit planes, including the compressed bit plane. The system may be used in a sensor network. The sensor network may have sensor nodes, like seismic sensing or weather sensing, with limited power.

In another configuration, the compressor may view a plurality of bits as a single number and compress the string of numbers with an appropriate code, such as a Golomb code. The plurality of bit planes may be adjacent bit planes either greater than (or equal to) or less than (or equal to) the threshold bit position value. The transmitter may transmit the uncompressed and compressed bit planes, including the compressed bit planes.

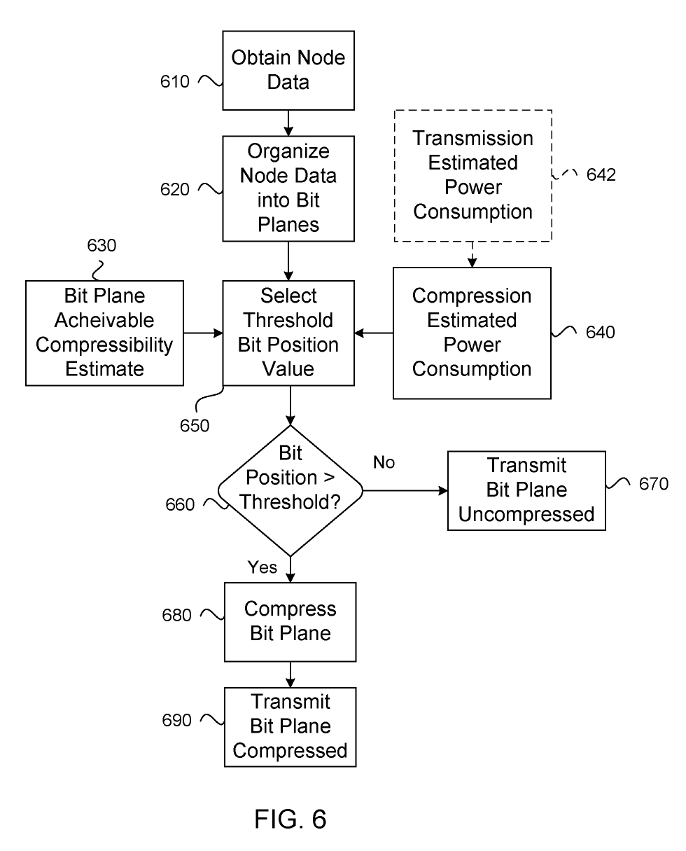

In another configuration, as illustrated in the flow chart in FIG. 6, the network node may obtain node data 610. The network node may organize the data stream of data units into bit planes 620. The network node may select a threshold bit position value 650. The threshold bit position may be selected because a compression and transmission of bit planes greater than the threshold bit position value may use less energy than just transmitting the bit planes uncompressed. An estimate of energy consumption used to transmit a bit plane 642 may be used in overall estimated energy consumption for a bit plane. The estimated energy consumption may include an energy consumption estimate for the compression process 640 used to compress the bit plane. Selecting a threshold bit position value may use the energy consumption estimate for the compression algorithm, the energy consumption estimate for transmission, or the bit plane achievable compressibility estimate 630. A selected bit plane may be compared with the threshold bit position value. If the bit position value for the selected bit plane is not greater than (less than or equal to) the threshold 660, then the selected bit plane may be transmitted uncompressed 670 to the network collector or another network node. If the bit position value for the selected bit plane is greater than the threshold 660, then the selected bit plane may be compressed 680 and then the compressed selected bit plane may be transmitted 690 to the network collector or another network node. Using the method illustrated in FIG. 6 may minimize the overall energy spent or consumed by a network node to transmit data.

A threshold bit position value may be selected once for a specified type of node data. The threshold bit position value may be stored and applied to a particular type of node data when a network node monitors different types of node data with different threshold bit positions for each type of node data. A threshold bit position value may be selected by sampling the node data and recalculating the threshold bit position on a periodic basis based on node data sampling. The threshold bit position value may be selected and adjusted using a power monitor for determining available power to the network node.

Natural signals may exhibit a degree of signal continuity. As a result, prediction error data and transform data resulting from cosine or wavelet transforms applied to raw collected data may be modeled by a discrete Laplacian distribution. The node data distribution or Laplacian distribution may have a decay factor that can utilize Golomb coding data compression. The statistics can estimate the rate of decay. A high decay rate may generate a high compression ratio. Golomb coding (or encoding) can have a lower complexity and lower power usage than more complex data compression coding.

A signal may be affected by noise which may have a maximum power level. The maximum power level of the noise may affect the values of some of the bit planes. Bit planes affected by noise may bypass the compression and remain uncompressed.

The network node may include a bit plane coder and a model of the node data. The model may be a two-sided geometric distribution (TSGD) with a selected rate of decay of the data. Compressibility can be estimated from computing the entropy for a model, like a TSGD model.

In another embodiment, compressibility may be estimated by first determining a first threshold bit position value such that bits below this threshold are deemed to be very noisy as determined by a statistical test on prediction errors. Such a statistical test is exemplified in Table 1. The entropy (or alternatively the average code length) of the statistical model applied to the less noisy bits is used as a measure of the compressibility of these bits, and the very noisy bits are stored or sent uncompressed, or even some of them may be discarded. Then, a second threshold bit position value is determined for the less noisy bits as illustrated in FIG. 4B in reference to the entire data. Bit positions below this second threshold are also stored or sent uncompressed, or even some of them may be discarded.

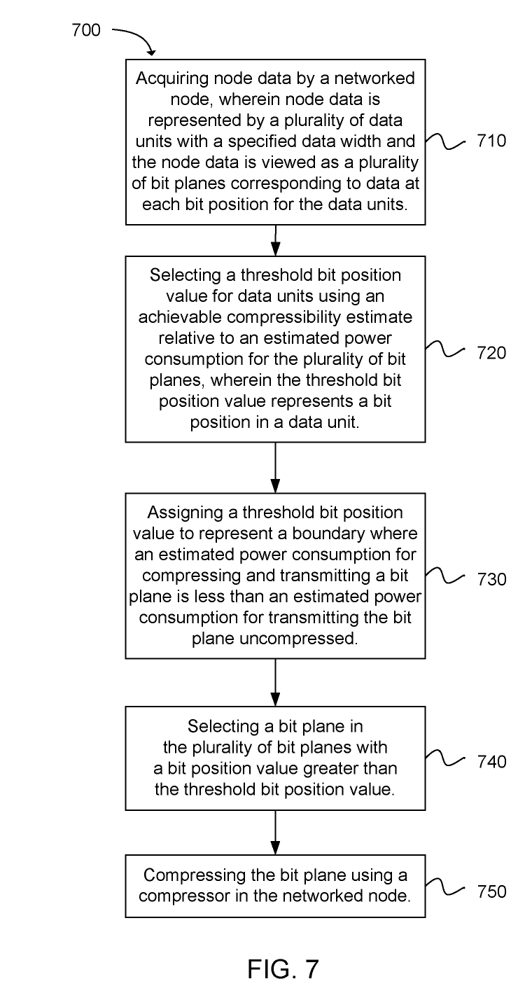

Another embodiment provides a method 700 for compressing digital discrete node data based on a bit position to reduce overall power consumption of a networked node, as shown in the flow chart in FIG. 7. The method includes the operation of acquiring 710 node data by a networked node. The node data can be represented by a plurality of data units with a specified data width and the node data is viewed as a plurality of bit planes corresponding to data at each bit position for the data units. The operation of selecting 720 a threshold bit position value for data units follows. The selection of threshold bit position value can use an achievable compressibility estimate relative to an estimated energy consumption for the plurality of bit planes. The threshold bit position value can represent a bit position in a data unit. The next operation of the method may be assigning 730 a threshold bit position value to represent a boundary where an estimated energy consumption for compressing and transmitting a bit plane is less than an estimated energy consumption for transmitting the bit plane uncompressed.

The method 700 further includes selecting 740 a bit plane in the plurality of bit planes with a bit position value greater than the threshold bit position value. The operation of compressing 750 the selected bit plane using a compressor in the networked node follows.

The method and system for compressing digital discrete node data based on a bit position to reduce overall power consumption of a networked node may be implemented using a computer readable medium having executable code embodied on the medium. The computer readable program code may be configured to provide the functions described in the method. The computer readable medium may be a RAM, EPROM, flash drive, optical drive, magnetic hard drive, or other medium for storing electronic data. Additionally, the method and system for compressing digital discrete node data based on a bit position to reduce overall power consumption of a networked node may be downloaded as a computer program product transferred from a server or remote computer to a requesting or client device by way of machine readable data signals embodied in a carrier wave or other propagation medium.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for compressing node data based on a bit position to reduce overall power consumption of a networked node, comprising:
acquiring node data by a networked node, wherein node data is represented by a plurality of data units with a specified data width and the node data is viewed as a plurality of bit planes corresponding to data at each bit position for the data units;
selecting a threshold bit position value for data units using an achievable compressibility estimate relative to an estimated energy consumption for the plurality of bit planes, wherein the threshold bit position value represents a bit position in a data unit;
assigning a threshold bit position value to represent a boundary where an estimated energy consumption for compressing and transmitting a bit plane is less than an estimated energy consumption for transmitting the bit plane uncompressed;
selecting a bit plane in the plurality of bit planes with a bit position value greater than the threshold bit position value; and
compressing the bit plane using a compressor in the networked node.

2. The method of claim 1, wherein the networked node includes a sensor.

3. The method of claim 1, wherein the estimated energy consumption for the plurality of bit planes estimates energy consumption of a compression process used by the compressor to compress each of the bit planes.

4. The method of claim 3, wherein the compression process includes Golomb encoding.

5. The method of claim 1, wherein selecting the threshold bit position value further comprises computing the prediction error for each truncated data sample corresponding to the bit planes used in determining the achievable compressibility estimate for each of the bit planes.

6. The method of claim 1, wherein the achievable compressibility estimate for the plurality of bit planes estimates a data compression ratio using a statistical model of each of the bit planes or collections of bit planes.

7. The method of claim 6, wherein the achievable compressibility estimate for the plurality of bit planes further comprises:
computing a first statistic for a prediction error from the plurality of bit planes and a second statistic for the prediction error from the plurality of bit planes;
determining a second threshold bit position value by comparing the value of a function of the first statistic to the second statistic and selecting the second threshold bit position value based on the comparison;
estimating a data compression ratio by computing the entropy of a statistical model of at least one of the plurality of bit planes with bit position values greater than the second threshold bit position value.

8. The method of claim 7, wherein the first statistic includes a sum of the absolute values and the second statistic includes the sum of the squares of signed data.

9. The method of claim 1, wherein the achievable compressibility estimate for the plurality of bit planes includes data compression ratios stored in the node related to node data for each of the bits planes, and estimated energy consumption includes energy consumption for a compression process in the node.

10. The method of claim 1, wherein the data units have a most significant bit (MSB) and a least significant bit (LSB), and the bit planes between the MSB and threshold bit position value including the MSB are compressed, and the bit planes between the LSB and threshold bit position value including the LSB and threshold bit position value are left uncompressed.

11. The method of claim 1, further comprising transmitting a remaining bit plane uncompressed to a network collector via wireless communication, wherein the remaining bit plane has the bit position value less than or equal to the threshold bit position value.

12. A method for compressing node data based on a bit position, comprising:
acquiring node data by a networked node, wherein node data is represented by a plurality of data units with a specified data width and the node data is viewed as a plurality of bit planes corresponding to data at each bit position for the data units;
selecting a threshold bit position value for data units using prediction errors for each of the plurality of bit planes, wherein the threshold bit position value represents a bit position in a data unit;
selecting a bit plane in the plurality of bit planes with a bit position value greater than the threshold bit position value; and
compressing the bit plane using a compressor in the networked node.

13. The method of claim 12, wherein selecting a threshold bit position value for data units using prediction errors for each of the plurality of bit planes further comprises:
computing a first statistic for a prediction error from each of the plurality of bit planes and a second statistic for each of the prediction error from the plurality of bit planes;
determining a threshold bit position value by comparing a value of a function of the first statistic to the second statistic and selecting the threshold bit position value based on the comparison.

14. The method of claim 13, wherein the first statistic includes a sum of the absolute values and the second statistic includes a sum of the squares of signed data.

15. A system for compressing sensor node data based on a bit position to reduce overall power consumption of a sensor networked node, comprising:
a sensor networked node for acquiring sensor node data, wherein sensor node data is represented by a plurality of data units with a specified data width and the sensor node data is viewed as a plurality of bit planes corresponding to data at each bit position for the data units;
a processor in the sensor networked node for selecting a threshold bit position value for data units using an achievable compressibility estimate relative to an estimated energy consumption for the plurality of bit planes, wherein the threshold bit position value represents a bit position in a data unit;
wherein the processor assigns a threshold bit position value to represent a boundary where an estimated energy consumption for compressing and transmitting a bit plane is less than an estimated energy consumption for transmitting the bit plane uncompressed for a bit position value greater than the threshold bit position value;
wherein the processor selects a bit plane in the plurality of bit planes with a bit position value greater than the threshold bit position value;
a compressor in the sensor networked node for compressing the bit plane;
a transmitter in the sensor networked node for transmitting uncompressed and compressed bit planes, including the bit plane;
a power source for powering the processor, the compressor, and the transmitter; and
a sensor that converts a measurable input into sensor node data.
